(19) United States
(12) Patent Application Publication
(10) Pub. No.: US 2026/0043725 A1
(43) Pub. Date: Feb. 12, 2026

(54) ELECTRODE TAB TENSILE STRENGTH TEST DEVICE AND ELECTRODE TAB TENSILE STRENGTH TEST METHOD

(71) Applicant: SK On Co., Ltd., Seoul (KR)

(72) Inventor: Jea Woo SUNG, Daejeon (KR)

(21) Appl. No.: 19/270,476

(22) Filed: Jul. 16, 2025

(30) Foreign Application Priority Data
Aug. 7, 2024 (KR) 10-2024-0105437

(51) Int. Cl. G01N 3/16; G01N 3/06

(52) U.S. Cl. CPC G01N 3/16; G01N 3/066

(57) ABSTRACT

According to the present disclosure, an electrode tab tensile strength test device is disclosed. The electrode tab tensile strength test device may include: a clamping member configured to pressurize an electrode tab of an electrode assembly; a driving member including a driving motor, and a gear member configured to convert driving force generated by the driving motor into linear motion, and configured to move the clamping member; and a sensor module connected to the clamping member and the gear member, and configured to change internal resistance based on a movement of the gear member.

### CROSS-REFERENCE TO RELATED APPLICATION(S)

This patent document claims the priority and benefits of Korean Patent Application No. 10-2024-0105437 filed on Aug. 7, 2024, the disclosure of which is incorporated herein by reference in its entirety.

### TECHNICAL FIELD

The disclosure and implementations disclosed in this patent document generally relate to an electrode tab tensile strength test device and an electrode tab tensile strength test method.

### BACKGROUND

Secondary batteries, unlike primary batteries, may be charged with or discharged of electricity, and may be applied to devices within various fields such as digital cameras, mobile phones, laptops, hybrid cars, electric cars, and energy storage systems (ESS). Secondary batteries may be lithium-ion batteries, nickel-cadmium batteries, nickel-metal hydride batteries, or nickel-hydrogen batteries.

Secondary batteries are manufactured as flexible pouch-type battery cells or rigid square or cylindrical can-type battery cells. A plurality of battery cells may be formed into a cell assembly in a stacked form.

The cell assembly may be disposed inside a module housing to form a battery module, and a plurality of battery modules may be disposed inside a pack frame to form a battery pack.

### SUMMARY

A battery cell may include an electrode assembly including a composite layer and a current collector, and an electrode tab connected to the current collector. The electrode tab may be welded to the current collector. However, due to wear and warpage of a welding device (e.g., to a horn and anvil), bonding strength of the electrode tab and the current collector may be reduced. When the bonding strength of the electrode tip and the current collector is reduced, mechanical or electrical problems may occur in the battery cell. Accordingly, an electrode tab tensile strength test may be required. However, if some of a plurality of battery cells are moved to a separate tensile strength test device, the moving time may be required, and errors due to an operator may occur.

According to an aspect of the present disclosure, an electrode tab tensile strength test device and an electrode tab tensile strength test method, which may reduce the tensile strength test time of an electrode tab may be provided.

According to an aspect of the present disclosure, an electrode tab tensile strength test device and an electrode tab tensile strength test method, which may reduce errors due to an operator, may be provided.

A battery cell manufactured by a battery cell manufacturing device (e.g., welding device) tested by an electrode tab tensile strength test device of the present disclosure may be widely applied to electric vehicles, battery charging stations, and devices within green technology fields such as solar power generation and wind power generation using other batteries. In addition, the battery cell manufactured by the battery cell manufacturing device (e.g., welding device) tested by the electrode tab tensile strength test device of the present disclosure may be used in eco-friendly electric vehicles and hybrid vehicles to ameliorate the effects of climate change by suppressing air pollution and greenhouse gas emissions.

An electrode tab tensile strength test device of the present disclosure may include: a clamping member configured to pressurize an electrode tab of an electrode assembly; a driving member including a driving motor, and a gear member configured to convert driving force generated by the driving motor into linear motion, and configured to move the clamping member; and a sensor module connected to the clamping member and the gear member, and configured to change internal resistance based on a movement of the gear member.

In an embodiment, the electrode tab tensile strength test device may further include a pressurizing device including a pressurizing jig configured to provide pressure to the electrode tab and a current collector of the electrode assembly, and a cylinder connected to the pressurizing jig.

In an embodiment, the pressurizing jig may be configured to provide pressure to the electrode tab and the current collector in a first direction. The clamping member is configured to pressurize the electrode tab in the first direction and provide tensile strength to the electrode tab in a second direction, perpendicular to the first direction, in a state in which the pressurizing jig pressurizes the electrode tab and the current collector.

In an embodiment, the pressurizing jig may include a first pressurizing jig configured to pressurize the electrode tab and the current collector from one side of the electrode tab, and a second pressurizing jig configured to pressurize the electrode tab and the current collector from the other side of the electrode tab.

In an embodiment, the pressurizing jig may include: a first pressurizing jig configured to pressurize at least one of the electrode tab or the current collector on one side of the electrode tab; and a second pressurizing jig configured to pressurize at least one of the electrode tab or the current collector on the other side of the electrode tab.

In an embodiment, the gear member may include at least one screw shaft, a nut connected to the screw shaft, a coupling connected to the screw shaft and the driving motor, and a plurality of balls disposed between the at least one screw shaft and the nut.

In an embodiment, the electrode tab tensile strength test device may further include a carrier configured to transfer the electrode assembly.

In an embodiment, the sensor module may be disposed between the clamping member and the driving member, and the sensor module may include a first end region connected to the clamping member and a second end region connected to the gear member.

In an embodiment, the clamping member may include a first pressurizing member in contact with one surface of the electrode tab, a second pressurizing member in contact with the other surface of the electrode tab, and a support portion connected to the first pressurizing member and the second pressurizing member, and the support portion may be connected to the sensor module.

In an embodiment, the electrode tab tensile strength test device may further include a processor configured to determine tensile strength of the electrode tab based on internal resistance sensed by the sensor module.

An electrode tab tensile strength test method of the present disclosure may include: a transfer process of transferring an electrode assembly including a current collector and bonded to an electrode tab; a pressurizing process of providing pressure to the electrode tab and the current collector using a pressurizing device; a fracture process of providing tensile strength to the electrode tab using a clamping member pressurizing the electrode tab and a sensor module connected to the clamping member; and a sensing process of sensing tensile strength of the electrode tab using the sensor module.

In an embodiment, the pressurizing process may provide pressure to the electrode tab and the current collector in a first direction using the pressurizing device. The fracture process may provide tensile strength to the electrode tab in a second direction, perpendicular to the first direction in a state in which the electrode tab is pressurized in the first direction.

In an embodiment, the transfer process may transfer the electrode assembly and the electrode tab in a third direction, perpendicular to the first direction or the second direction, using a carrier.

According to an embodiment of the present disclosure, the time for testing the tensile strength of the electrode tab may be reduced.

According to an embodiment of the present disclosure, the accuracy of testing tensile strength of an electrode tab may be improved.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIG. 2 is a schematic diagram illustrating a welding process of an electrode assembly and an electrode tab according to an embodiment.

FIG. 3 is a perspective view of an electrode tab tensile strength test device according to an embodiment.

FIG. 4 is a flow chart of an electrode tab tensile strength test method according to an embodiment.

### DETAILED DESCRIPTION

Hereinafter, features of the present disclosure disclosed in this patent document are described by example embodiments with reference to the accompanying drawings. However, these are merely exemplary and the present disclosure is not limited to the specific embodiments described by way of example.

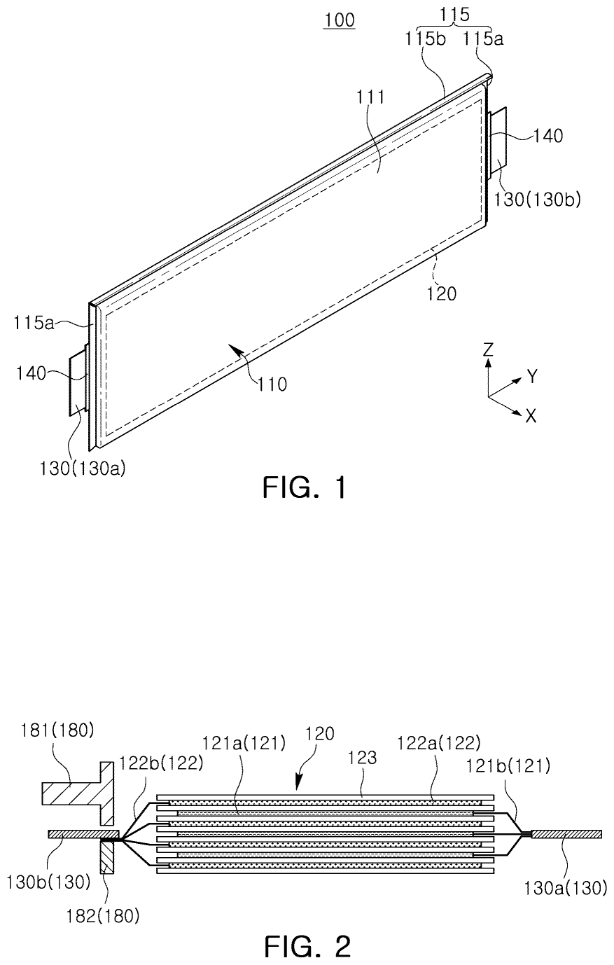

FIG. 1 is a perspective view of a battery cell according to an embodiment.

Referring to FIG. 1, a battery cell 100 may include a pouch 110, an electrode assembly 120, and an electrode tab 130. The battery cell 100 may be a secondary battery. For example, the battery cell 100 may be a lithium ion battery, but the present disclosure is not limited thereto. For example, the battery cell 100 may be a nickel-cadmium battery, a nickel-metal hydride battery, or a nickel-hydrogen battery, which may be charged with or discharged of electricity.

The pouch 110 may form at least a portion of an exterior of the battery cell 100. The pouch 110 may include an electrode accommodation portion 111 accommodating the electrode assembly 120, and a sealing portion 115 sealing at least a portion of a periphery of the electrode accommodation portion 111. The electrode accommodation portion 111 may provide a space in which the electrode assembly 120 and an electrolyte are accommodated.

The sealing portion 115 may be formed by bonding at least a portion of a periphery of the pouch 110. The sealing portion 115 may be formed in a flange shape expanded outwardly from the electrode accommodation portion 111 formed in a container shape, and may be disposed along at least a portion of an outer periphery of the electrode accommodation portion 111. In an embodiment, the sealing portion 115 may include a first sealing portion 115a in which the electrode tab 130 is disposed and a second sealing portion 115b in which the electrode tab 130 is not disposed. A portion of the electrode tab 130 may be drawn out or exposed to the outside of the pouch 110. In a position in which the electrode tab 130 is drawn out, in order to increase a sealing degree of the first sealing portion 115a and secure an electrical insulation state at the same time, the electrode tab 130 may be covered by an insulating film 140. The insulating film 140 may be formed of a film material thinner than the electrode tab 130 and may be attached to both sides of the electrode tab 130.

The electrode assembly 120 may be welded to the electrode tab 130. A current of the electrode assembly 120 may be transmitted to the outside of the battery cell 100 through the electrode tab 130. The electrode assembly 120 is further described below.

In an embodiment, the electrode tabs 130 may be disposed on opposite sides of the battery cell 100 in a longitudinal direction (Y-axis direction). For example, the electrode tab 130 may include a first electrode tab 130a (e.g., a cathode tab) having a first polarity (e.g., a cathode) facing one side of the battery cell 100 in the longitudinal direction, and a second electrode tab 130b having a second polarity (e.g., an anode electrode) facing the other side thereof in the longitudinal direction. In the embodiment illustrated in FIG. 1, the sealing portion 115 may include two first sealing portions 115a in which the electrode tab 130 is disposed and one second sealing portion 115b in which the electrode tab 130 is not disposed. The first sealing portion 115a may seal at least a portion of the electrode tabs 130. In an embodiment, the electrode tab 130 may be referred to as an electrode lead.

A direction in which the electrode tab 130 is disposed may be selectively designed. In an embodiment (e.g., FIG. 1), the electrode tabs 130 may include a first electrode tab 130a and a second electrode tab 130b disposed in an opposite direction of the first electrode tab 130a based on the electrode assembly 120. In FIG. 1, the electrode tabs 130 disposed to be oriented in opposite directions on both sides of the battery cell 100 in the longitudinal direction (e.g., Y-axis direction) are shown, but the structure of the electrode tab 130 is not limited thereto. For example, two electrode tabs 130 may be arranged to be substantially parallel in the longitudinal direction (e.g., Y-axis direction) of the battery cell 100. Meanwhile, the pouch 110 is not limited to a structure in which a single sheet of outer material is folded to form a sealing portion 115 on three surfaces, as shown in FIG. 1.

In an embodiment of the present disclosure, at least a portion of the sealing portion 115 may be formed in a form folded at least once. By folding at least a portion of the sealing portion 115, the bonding reliability of the sealing portion 115 may be improved, and an area of the sealing portion 115 may be minimized. According to an embodiment, the second sealing portion 115b in which the electrode tab 130 is not disposed, among the sealing portions 115, may be fixed by an adhesive member (not shown) after the second sealing portion 115b is folded twice. An angle at which the second sealing portion 115b is bent or the number of times in which the second sealing portion 115b is bent may be changed. For example, in an embodiment not shown, the second sealing portion 115b may be folded by 90° based on the first sealing portion 115a.

FIG. 2 is a schematic diagram illustrating a welding process of an electrode assembly and an electrode tab according to an embodiment.

Referring to FIG. 2, the electrode assembly 120 may be welded to the electrode tab 130 using a welding device 180. The description of the electrode assembly 120 and the electrode tab 130 of FIG. 1 may be applied to the electrode assembly 120 and the electrode tab 130 of FIG. 2.

The electrode assembly 120 may include a cathode 121, an anode 122, and a separator 123. The cathode 121 may include a cathode current collector 121b and a cathode composite layer 121a disposed on at least one surface of the cathode current collector 121b. The cathode current collector 121b may include stainless steel, nickel, aluminum, titanium, or alloys thereof. The cathode current collector 121b may include aluminum or stainless steel surface-treated with carbon, nickel, titanium or silver. The cathode composite layer 121a may include a cathode active material. The cathode active material may include a compound capable of reversibly intercalating and deintercalating lithium ions. The anode 122 may include an anode current collector 122b and an anode composite layer 122a disposed on at least one surface of the anode current collector 122b. The anode current collector 122b may include, as non-limiting examples, copper foil, nickel foil, stainless steel foil, titanium foil, nickel foam, copper foam, and/or a polymer substrate coated with a conductive metal. The anode composite layer 122a may include an anode active material. A material capable of adsorbing and desorbing lithium ions may be used as the anode active material. The separator 123 may prevent contact between the cathode 121 and the anode 122.

The number of cathodes 121, anodes 122, and/or separators 123 may be selectively designed. For example, the electrode assembly 120 may include a plurality of cathodes 121, a plurality of anodes 122, and/or a plurality of separators 123.

A person skilled in the art will appreciate that the electrode assembly 120 may be manufactured using a variety of methods. According to example embodiments, the cathode 121, the anode 122, and the separator 123 may be repeatedly disposed to form the electrode assembly. In some embodiments, an electrode assembly may be of a winding type, a stacking type, a zigzag-folding (Z-folding) type, or a stack-folding type.

The current collectors 121b and 122b of the electrode assembly 120 may be bonded to the electrode tabs 130. For example, the cathode current collector 121b may be welded to the first electrode tab 130a, and the anode current collector 122b may be welded to the second electrode tab 130b. In an embodiment, the current collectors 121b and 122b may be referred to as foils.

In an embodiment, the welding device 180 may be an ultrasonic welding device. For example, the welding device 180 may include a horn 181 and an anvil 182. The horn 181 may pressurize welding objects (e.g., the electrode tab 130 and the current collectors 121b and 122b). The horn 181 may provide vibration to the welding objects (e.g., the electrode tab 130 and the current collectors 121b and 122b). The anvil 182 may support and/or secure the welding objects (e.g., the electrode tab 130 and the current collectors 121b and 122b). The anvil 182 may maintain the pressure transmitted from the horn 181 to the welding objects (e.g., the electrode tab 130 and the current collectors 121b and 122b). The horn 181 may be disposed on one side of the electrode tab 130, and the anvil 182 may be disposed on the other side of the electrode tab 130. At least a portion of the electrode tab 130 and the current collectors 121b and 122b may be inserted between the horn 181 and the anvil 182 and may then be welded by the horn 181 and the anvil 182.

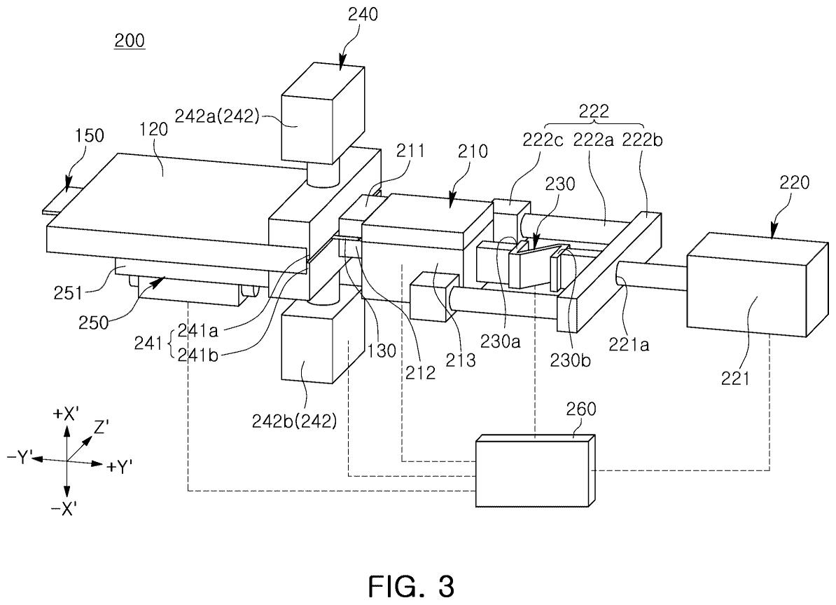

FIG. 3 is a perspective view of an electrode tab tensile strength test device according to an embodiment.

Referring to FIG. 3, an electrode tab tensile strength test device 200 may include a clamping member 210, a driving member 220, and a sensor module 230.

The electrode tab tensile strength test device 200 may test the bonding strength (e.g., the tensile strength of the electrode tab 130) of the electrode tab 130 (e.g., the electrode tab 130 of FIG. 2) and the current collector (e.g., the current collectors 121b and 122b of FIG. 2). For example, the welding device 180 of FIG. 2 may be worn. When the horn 181 and/or the anvil 182 are worn, the tensile strength of the electrode tab 130 and the current collectors 121b and 122b may be reduced. When the tensile strength of the electrode tab 130 is reduced, the durability of the battery cell 100 may be reduced. When the tensile strength of the electrode tab 130 is reduced, the possibility of electrical problems occurring in the battery cell 100 may increase. In an embodiment, the tensile strength of the electrode tab 130 may be force applied when the electrode tab 130 welded to the current collectors 121b and 122b is pulled in a second direction (e.g., +Y′-direction) until the electrode tab 130 and the current collectors 121b and 122b are fractured. The electrode tab tensile strength test device 200 may test the electrode tab tensile strength in a product 150 during production that includes the electrode assembly 120 and the electrode tab 130. The product 150 during the production may include an electrode assembly 120 and electrode tab 130 temporarily bonded to the current collectors 121b and 122b of the electrode assembly 120. By means of an electrode tab tensile strength test device 200, the aging, wear and/or warpage of a welding device (e.g., the welding device 180 of FIG. 2) welding the electrode tab 130 and current collectors 121b and 122b of the battery cell 100 may be tested. For example, when the electrode tab tensile strength is less than a specified magnitude, the aging, wear and/or warpage of the welding device 180 may be determined to be greater than a specified magnitude.

The clamping member 210 may pressurize the electrode tab 130. For example, the clamping member 210 may be moved to a state in which the clamping member 210 is in contact with the electrode tab 130 and pressurizes the electrode tab 130, and may provide tensile strength to the electrode tab 130.

In an embodiment, the clamping member 210 may include a first pressurizing member 211 in contact with one surface of the electrode tab 130, a second pressurizing member 212 in contact with the other surface of the electrode tab 130, and a support portion 213 connected to the first pressurizing member 211 and the second pressurizing member 212. The first pressurizing member 211 and the second pressurizing member 212 may secure the electrode tab 130. At least a portion of the electrode tab 130 may receive force from the first pressurizing portion 211 and the second pressurizing portion 212, in a state of being disposed between the first pressurizing portion 211 and the second pressurizing portion 212. The support portion 213 may be connected to the sensor module 230. The clamping member 210 may be disposed between the electrode tab 130 and the sensor module 230. One side of the support portion 213 may be connected to the pressurizing portions 211 and 212, and the other side thereof may be connected to the sensor module 230.

The clamping member 210 may be moved in a state in which a pressurizing jig 241 of a pressurizing device 240 pressurizes the electrode tab 130 and/or the current collectors 121b and 122b. For example, the pressurizing jig 241 may provide pressure to the electrode tab 130 and the current collectors 121b and 122b in a first direction (e.g., X′-axis direction). The clamping member 210 may pressurize the electrode tab 130 in the first direction (e.g., X′-axis direction) in a state in which the pressurizing jig 241 pressurizes the electrode tab 130 and the current collectors 121b and 122b, and may provide tensile strength to the electrode tab 130 in a second direction (e.g., +Y′-direction), perpendicular to the first direction (e.g., X′-axis direction). The clamping member 210 may pull the electrode tab 130 in the second direction (e.g., +Y′-direction).

The driving member 220 may move at least a portion of the electrode tab tensile strength test device 200. For example, the driving member 220 may move the clamping member 210 and/or the sensor module 230.

The driving member 220 may include a driving motor 221. The driving motor 221 may be configured to generate driving force. The driving motor 221 may convert electric energy supplied from a battery or an external power source into rotational energy. The driving motor 221 may include a motor end 221a connected to a gear member 222. The driving motor 221 may transmit rotational force to the gear member 222 through the motor end 221a. The driving motor 221 may be a servo motor or a linear motor. The driving motor 221 may rotate about the second direction (+Y′ direction) as an axis.

The driving member 220 may include a gear member 222 configured to convert driving force generated by the driving motor 221 into linear motion. In an embodiment, the gear member 222 may include a ball screw. For example, the gear member 222 may include at least one screw shaft 222a, a nut 222c connected to a screw shaft 222a, and a coupling 222b connected to an end of the screw shaft 222a and the motor end 221a of the driving motor 221. The gear member 222 may include a plurality of balls (e.g., bearings) (not shown) disposed between the screw shaft 222a and the nut 222c.

When the driving motor 221 rotates, at least a portion of the gear member 222 (e.g., the screw shaft 222a and/or the coupling 222b) may move in the second direction (e.g., +Y′-direction) or a fourth direction (e.g., −Y′-direction) opposite to the second direction (e.g., +Y′-direction). The coupling 222b may be connected to the sensor module 230. For example, the sensor module 230 may receive force based on the movement of the coupling 222b. In an embodiment, the nut 222c may be fixed to an external structure (not shown) of the electrode tab tensile strength test device 200. When the driving motor 221 rotates, a distance between the nut 222c and the coupling 222b may be changed.

In an embodiment, the driving motor 221 and/or the gear member 222 may be replaced with a component for providing force to the clamping member 210 and the sensor module 230 in the second direction (e.g., +Y′-direction) or in the fourth direction (e.g., −Y′-direction) opposite to the second direction (e.g., +Y′-direction). For example, the driving motor 221 may include a linear motor. The gear member 222 may include a linear motion guide or a cam follower.

The sensor module 230 may be configured to change internal resistance based on the movement of the gear member 222. For example, in an embodiment, the sensor module 230 may be a tensile load cell. The tensile load cell may be a sensor (e.g., a strain gauge) that includes a strain gauge converting deformation (e.g., warpage) into electrical resistance. For example, the tensile load cell may include an elastic body configured to deform based on external force (e.g., tensile strength) and a gauge whose resistance value changes based on the deformation of the elastic body. The sensor module 230 may have a shape for sensing pressure based on the tensile strength. The sensor module 230 may convert force or weight into an electrical signal. When the gear member 222 moves, the force or weight sensed by the sensor module 230 connected to the clamping member 210 changes, and a value of the electrical signal transmitted by the sensor module 230 to a processor 260 may be changed. The sensor module 230 may include a strain gauge. The sensor module 230 may be referred to as a pressure sensor.

The sensor module 230 may be connected to the clamping member 210 and the gear member 222. For example, the sensor module 230 may be disposed between the clamping member 210 and the driving member 220. The sensor module 230 may include a first end region 230a connected to the clamping member 210 and a second end region 230b connected to the gear member 222. The sensor module 230 may be connected to the support 213 of the clamping member 210 and the coupling 222b of the gear member 222.

The sensor module 230 may sense the tensile strength provided to the electrode tab 130. For example, the sensor module 230 may receive force based on the movement of the driving member 220. At least a portion of the force generated by the driving motor 221 of the driving member 220 may be transmitted to the electrode tab 130 through the sensor module 230 and the clamping member 210. When a portion of the gear member 222 moves in the second direction (e.g., +Y′-direction), the sensor module 230 and the clamping member 210 may receive force in the second direction (e.g., +Y′-direction). The sensor module 230 may sense the tensile strength until the electrode tab 130 is fractured with respect to the current collectors 121b and 122b of FIG. 2 after the operation of the driving motor 221.

In an embodiment, the electrode tab tensile strength test device 200 may be subject to unitization and modularization. The electrode tab tensile strength test device 200 may measure the tensile strength of the electrode tab 130 when the electrode tab 130 and the current collectors 121b and 122b are welded or pressurized. For example, the electrode tab tensile strength test device 200 may determine the tensile strength of the electrode tab 130 by applying force to the electrode tab 130 when the electrode tab 130 and the current collectors 121b and 122b are welded.

The electrode tab tensile strength test device 200 may include a pressurizing device 240. The pressurizing device 240 may include a pressurizing jig 241 and a cylinder 242. The pressurizing jig 241 may provide pressure to the electrode tab 130 and/or the current collectors 121b and 122b. For example, the pressurizing jig 241 may include a first pressurizing jig 241a pressurizing the electrode tab 130, and a second pressurizing jig 241b pressurizing the current collectors 121b and 122b. The cylinder 242 may be connected to the pressurizing jig 241. The cylinder 242 may move the pressurizing jig 241. For example, the pressurizing jig 241 and/or the cylinder 242 may move along the first direction (X′-axis direction). The pressurizing jig 241 may provide pressure to the electrode tab 130 and/or the current collectors 121b and 122b on both sides of the electrode tab 130 and/or the current collectors 121b and 122b. For example, the pressurizing jig 241 may include a first pressurizing jig 241a configured to pressurize at least one of the electrode tab 130 or the current collectors 121b and 122b on one side of the electrode tab 130, and a second pressurizing jig 241b configured to pressurize at least one of the electrode tab 130 or the current collectors 121b and 122b on the other side of the electrode tab 130.

In an embodiment, the pressurizing device 240 may weld the electrode tab 130 and the current collector (e.g., the current collectors 121b and 122b of FIG. 2). The pressurizing device 240 may be referred to as a welding device. At least a portion of the description of the welding device 180 of FIG. 2 may be applied to the pressurizing device 240 of FIG. 3. For example, the pressurizing device 240 may be an ultrasonic welding device. The pressurizing device 240 may include a horn (e.g., the horn 181 of FIG. 2) and an anvil (e.g., the anvil 182 of FIG. 2).

In another embodiment, the pressurizing device 240 may be a separate device separate from the welding device 180. For example, the electrode tab tensile strength test device 200 may test the electrode tab tensile strength of an in-production product 150 welded in the welding device 180. A carrier 250 may move the in-production product 150 manufactured in the welding device 180 of FIG. 2. The pressurizing device 240 may pressurize the electrode tab 130 and the current collectors 121b and 122b of the in-production product 150.

The electrode tab tensile strength test device 200 may include the carrier 250. The carrier 250 may move the in-production product 150. For example, the carrier 250 may transfer the electrode assembly 120 and/or the electrode tab 130. For example, in an embodiment, the carrier 250 may include a conveyor belt 251 configured to support the electrode assembly 120 and move the electrode assembly 120. In another embodiment, the carrier 250 may be a transfer jig for moving the electrode assembly 120. In an embodiment, the carrier 250 may transfer the electrode assembly 120 and the electrode tab 130 in a third direction (e.g., Z′-axis direction), perpendicular to the first direction (e.g., X′-axis direction) or the second direction (e.g., +Y′-axis direction). In an embodiment, the carrier 250 may be referred to as a transfer device.

The electrode tab tensile strength test device 200 may include a processor 260. The sensor module 230 may be electrically connected to the processor 260. An electrical signal sensed by the sensor module 230 may be transmitted to the processor 260. The processor 260 may determine the tensile strength of the electrode tab 130 based on the internal resistance sensed by the sensor module 230. For example, the sensor module 230 may include an elastic body configured to be deformed based on external force, and a gauge (e.g., a strain gauge) configured to have a resistance value deformed based on the deformation of the elastic body. The processor 260 may determine the tensile strength of the electrode tab 130 based on changing internal resistance of the sensor module 230. In an embodiment, a memory (not shown) may store the tensile strength corresponding to an internal resistance value. The processor 260 may determine the tensile strength of the electrode tab 130 corresponding to the internal resistance sensed by the sensor module 230 using the memory.

In an embodiment, the processor 260 may transmit the tensile strength of the electrode tab 130 to a manufacturing execution system (MES) through a communication module (not shown). In an embodiment, the processor 260 may control the movement of the clamping member 210, the driving member 220, the welding device 240, and/or the carrier 250.

By utilizing the electrode tab tensile strength test device 200, the tensile strength of the electrode tab 130 may be tested without moving the product 150 in which the electrode assembly 120 and the electrode tab 130 are combined during production. By means of the electrode tab tensile strength test device 200, the moving time and the sampling time of an operator may not be required, and the test time of the battery cell 100 may be shortened.

By utilizing the electrode tab tensile strength test device 200, a position for fixing the electrode tab 130 may be maintained to be substantially the same, and the pressure transmitted to the electrode tab 130 may be controlled. By means of the electrode tab tensile strength test device 200, errors caused by the operator may be reduced, and the accuracy of the tensile strength test of the electrode tab 130 may be improved.

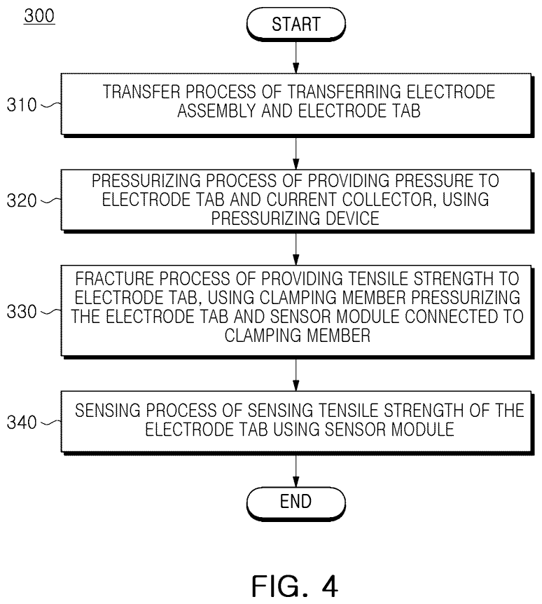

FIG. 4 is a flow chart of an electrode tab tensile strength test method according to an embodiment.

Referring to FIG. 4 together with FIG. 3, an electrode tab tensile strength test method 300 may include a transfer process 310, a pressurizing process 320, a fracture process 330, and/or a sensing process 340. The electrode tab tensile strength test method 300 may be performed by the electrode tab tensile strength test device 200 of FIG. 3.

The transfer process 310 may be a process of transferring an electrode assembly 120 including current collectors 121b and 122b and bonded to an electrode tab 130. For example, the transfer process 310 may be performed using the carrier 250 of FIG. 3. In an embodiment, the transfer process 310 may transfer the electrode assembly 120 and the electrode tab 130 in the third direction (e.g., Z′-axis direction), perpendicular to the first direction (X′-axis direction of FIG. 3) or the second direction (+Y′-axis direction of FIG. 3), using the carrier 250.

The pressurizing process 320 may be a process of providing pressure to the electrode tab 130 and the current collectors 121b and 122b using the pressurizing device (e.g., the pressurizing device 240 of FIG. 3). In an embodiment, the pressurizing process 320 may provide pressure to the electrode tab 130 and the current collectors 121b and 122b in the first direction (e.g., X′-axis direction of FIG. 3) using the pressurizing device 240.

For example, the pressurizing process 320 may provide pressure on both sides of the electrode tab 130 and the current collectors 121b and 122b using a pressurizing jig (e.g., the pressurizing jig 241 of FIG. 3). Positions of the electrode tab 130 and the current collectors 121b and 122b may be fixed by the pressure of the pressurizing device 240 received in the pressurizing process 320.

In an embodiment, the pressurizing process 320 may be a process of pressurizing the electrode tab 130 and the current collectors 121b and 122b after welding the electrode tab 130 and the current collectors 121b and 122b. In another embodiment, the pressurizing process 320 may be a welding process of welding the electrode tab 130 and the current collectors 121b and 122b.

The fracture process 330 may be a process of providing tensile strength to the electrode tab 130 using a clamping member 210 pressurizing the electrode tab 130 and a sensor module 230 connected to the clamping member 210. The fracture process 330 may provide the tensile strength to the electrode tab 130 in the second direction (e.g., +Y′-direction), perpendicular to the first direction (e.g., X′-direction) in a state in which the electrode tab 130 is pressurized in the first direction (e.g., X′-direction). For example, the fracture process 330 may provide force in the second direction (+Y′-direction) to the sensor module 230 using the driving member 220. For example, the fracture process 330 may be a process of operating the driving motor 221 of the driving member 220 to move the gear member 222 connected to the driving motor 221. In the fracture process 330, the sensor module 230 connected to the gear member 222 may receive the force in the second direction (+Y′ direction). The clamping member 210 connected to the sensor module 230 may receive the force in the second direction (+Y′ direction) from the driving member 220 through the sensor module 230. The electrode tab 130 connected to the clamping member 210 may receive the force in the second direction (+Y′ direction). The tensile strength provided to the electrode tab 130 may be force transmitted to the electrode tab 130 in the second direction (e.g., +Y′-direction). When the force transmitted to the electrode tab 130 is greater than bonding force between the electrode tab 130 and the current collector (e.g., the current collectors 121b and 122b of FIG. 2), the electrode tab 130 may be fractured. The fracture of the electrode tab 130 may be separation or breakage of the electrode tab 130 and the current collectors 121b and 122b. The fracture process 330 may be performed during the pressurizing process 320. For example, in a state in which a position of the electrode tab 130 is fixed by the pressurizing device 240, the driving member 220 may provide tensile strength to the electrode tab 130 using the sensor module 230 and the clamping member 210.

The sensing process 340 may be a process of sensing the tensile strength of the electrode tab 130 using the sensor module 230. For example, the internal resistance of the sensor module 230 may be changed based on the force transmitted in the fracture process 330. The processor 260 may determine the tensile strength of the electrode tab 130 based on the internal resistance of the sensor module 230 sensed in the sensing process. The sensing process 340 may be performed substantially simultaneously with the fracture process 330. For example, the sensing process 340 may be performed from the time when the tensile strength is applied to the sensor module 230 by driving the driving member 220 until the electrode tab 130 is fractured.

The above-described content is merely an example of applying the principle of the present disclosure, and other components may be further included within a scope that does not exceed the scope of the present disclosure.

For example, the present disclosure may be implemented by deleting some components from the above-described embodiments, and each embodiment may be implemented in combination with each other.

What is claimed is:

1. An electrode tab tensile strength test device, comprising:
a clamping member configured to pressurize an electrode tab of an electrode assembly;
a driving member including a driving motor, and a gear member configured to convert driving force generated by the driving motor into linear motion, and configured to move the clamping member; and
a sensor module connected to the clamping member and the gear member, and configured to change internal resistance based on a movement of the gear member.

2. The electrode tab tensile strength test device of claim 1, further comprising:
a pressurizing device including a pressurizing jig configured to provide pressure to the electrode tab and a current collector of the electrode assembly, and a cylinder connected to the pressurizing jig.

3. The electrode tab tensile strength test device of claim 2, wherein the pressurizing jig is configured to provide pressure to the electrode tab and the current collector in a first direction, and
the clamping member is configured to pressurize the electrode tab in the first direction in a state in which the pressurizing jig pressurizes the electrode tab and the current collector, and provide tensile strength to the electrode tab in a second direction, perpendicular to the first direction.

4. The electrode tab tensile strength test device of claim 2, wherein the pressurizing jig includes:
a first pressurizing jig configured to pressurize at least one of the electrode tab or the current collector on one side of the electrode tab; and
a second pressurizing jig configured to pressurize at least one of the electrode tab or the current collector on the other side of the electrode tab.

5. The electrode tab tensile strength test device of claim 1, wherein the gear member includes at least one screw shaft, a nut connected to the screw shaft, a coupling connected to the screw shaft and the driving motor, and a plurality of balls disposed between the at least one screw shaft and the nut.

6. The electrode tab tensile strength test device of claim 1, further comprising:
a carrier configured to transfer the electrode assembly.

7. The electrode tab tensile strength test device of claim 1, wherein the sensor module is disposed between the clamping member and the driving member, and
the sensor module includes a first end region connected to the clamping member and a second end region connected to the gear member.

8. The electrode tab tensile strength test device of claim 1, wherein the clamping member includes a first pressurizing member in contact with one surface of the electrode tab, a second pressurizing member in contact with the other surface of the electrode tab, and a support portion connected to the first pressurizing member and the second pressurizing member, and
the support portion is connected to the sensor module.

9. The electrode tab tensile strength test device of claim 1, further comprising:
a processor configured to determine tensile strength of the electrode tab based on internal resistance sensed by the sensor module.

10. An electrode tab tensile strength test method, comprising:
a transfer process of transferring an electrode assembly including a current collector and bonded to an electrode tab;
a pressurizing process of providing pressure to the electrode tab and the current collector using a pressurizing device;
a fracture process of providing tensile strength to the electrode tab using a clamping member pressurizing the electrode tab and a sensor module connected to the clamping member; and
a sensing process of sensing tensile strength of the electrode tab using the sensor module.

11. The electrode tab tensile strength test method of claim 10, wherein the pressurizing process provides pressure to the electrode tab and the current collector in a first direction using the pressurizing device, and
the fracture process provides tensile strength to the electrode tab in a second direction, perpendicular to the first direction, in a state in which the electrode tab is pressurized in the first direction.

12. The electrode tab tensile strength test method of claim 11, wherein the transfer process transfers the electrode assembly and the electrode tab in a third direction, perpendicular to the first direction or the second direction, using a carrier.
